(19) United States
(12) Patent Application Publication
(10) Pub. No.: US 2017/0088101 A1
(43) Pub. Date: Mar. 30, 2017

(54) WINDSHIELD WIPER

(71) Applicant: GM GLOBAL TECHNOLOGY OPERATIONS LLC, Detroit, MI (US)

(72) Inventor: Claus STELLER, Ruesselsheim (DE)

(73) Assignee: GM GLOBAL TECHNOLOGY OPERATIONS LLC, Detroit, MI (US)

(21) Appl. No.: 15/280,140

(22) Filed: Sep. 29, 2016

(30) Foreign Application Priority Data
Sep. 29, 2015 (DE) 102015012610.5

(51) Int. Cl. B60S 1/52; B60S 1/38

(52) U.S. Cl. CPC B60S 1/524; B60S 1/3856

(57) ABSTRACT

A windshield wiper for a motor vehicle includes an elongate wiper blade and a supply conduit for cleaning fluid leading to outlet openings formed on both sides of the wiper blade. A directional control valve is provided to selectively supply cleaning fluid to either the outlet openings on the first side or the outlet openings on the second side of the wiper blade based on the wiping direction of the wiper blade.

### CROSS-REFERENCE TO RELATED APPLICATION

This application claims priority to German Patent Application No. 102015012610.5, filed Sep. 29, 2015, which is incorporated herein by reference in its entirety.

### TECHNICAL FIELD

The present disclosure pertains to a windshield wiper for a motor vehicle.

### BACKGROUND

Conventional windshield wipers usually have a bracket, in which a flexible wiper blade is held. The bracket is mounted on a wiper arm of the motor vehicle in such a way that the wiper arm presses the wiper blade against the surface of a windshield to be cleaned. The wiper blade is moved over the windshield transverse to its longitudinal direction due to pivoting motions of the wiper arm in order to push aside water located on the windshield. A cleaning fluid can be applied onto the windshield in order to additionally dissolve and remove fatty and albuminous films and coatings or to remove dirt from dry windshields.

Such cleaning fluids are traditionally applied with the aid of spray nozzles that are mounted on the engine hood and continuously spray as long as the driver actuates a corresponding lever. In this way, nearly the entire windshield is wetted with cleaning fluid including the part of the windshield, over which the wiper blade has just passed. The windshield can be quickly and efficiently cleaned since the wiper blade sweeps over a windshield wetted with cleaning fluid during the forward and the backward motion of the windshield wiper. However, the consumption of cleaning fluid is quite high and the visibility is restricted while the windshield is cleaned.

In certain windshield wiper blades, such as the AquaBlade® made by Valeo, outlet openings for cleaning fluid are directly integrated into the windshield wiper on one side of the wiper blade. The cleaning fluid is only applied onto the windshield when the outlet openings lie in front of the wiper blade referred to the moving direction of the windshield wiper. In this way, the cleaning fluid is captured by the wiper blade immediately after it is applied onto the windshield and therefore cannot impair the visibility. During the motion in the opposite direction, however, such wiper blades sweep over a dry windshield. Intensive cleaning therefore is only possible during every other motion of the windshield wiper such that the cleaning process is considerably prolonged.

### SUMMARY

The present disclosure provides a windshield wiper that makes it possible to quickly clean a windshield and only consumes little cleaning fluid for this purpose. According to an embodiment of the present disclosure, a windshield wiper for a motor vehicle is equipped with an elongate wiper blade and a supply conduit for cleaning fluid leading to at least one respective outlet opening on both sides of the wiper blade. In this way, cleaning fluid can be applied onto a windshield along the wiper blade during a forward motion, as well as during a backward motion, and the windshield can be effectively cleaned in both moving directions of the windshield wiper.

Multiple outlet openings may be distributed along the wiper blade in order to apply the cleaning fluid onto the windshield over the entire length of the wiper blade. The supply conduit should include a distribution line that extends along the wiper blade between the outlet openings and supplies the outlet openings with cleaning fluid.

In order to prevent cleaning fluid from being continuously discharged through the outlet openings on both sides of the wiper blade during a wiping process and to prevent the visibility from being impaired by cleaning fluid that runs off the side of the wiper blade facing away from the wiping direction, a directional control valve should be provided for either supplying the outlet openings on the first side or the outlet openings on the second side of the wiper blade with cleaning fluid.

The wiper blade may be tiltable about a longitudinal axis in a mounting. In this case, the directional control valve can be coupled to the tilting motion in order to supply the outlet opening on the first side with cleaning fluid when the wiper blade is tilted toward the second side. Since the wiper blade is alternately tilted during each change between the forward and the backward motion of the windshield wiper, only the outlet opening lying in front of the wiper blade referred to the moving direction is respectively open.

In an embodiment, the wiper blade may be accommodated in a groove of a wiper bracket. In order to enable the wiper blade to adapt to the direction of the wiping motion and to tightly adapt to the windshield, at least one sidewall of the groove and a flank of the wiper blade lying opposite of this sidewall should be spaced apart from one another.

It is advantageous if the outlet openings respectively lead into gaps between a flank of the wiper blade and an opposing sidewall of the groove. When the wiper moves over the windshield, the mobility of the wiper blade causes the gap on the front side of the wiper blade relative to the moving direction to open and the gap on the rear side of the wiper blade relative to the moving direction to close. The respective sidewalls of the groove function as a valve seat and the wiper blade functions as a closing body of the directional control valve, which can be moved between the valve seats, such that cleaning fluid can only be discharged into the gap and subsequently onto the windshield through the outlet openings on the front side of the wiper blade relative to the moving direction. In order to convey cleaning fluid to the outlet openings, a downstream section of the supply conduit may extend in the sidewalls of the groove.

In another embodiment of the present disclosure, the groove may feature an undercut inner region, into which a leg of the wiper blade engages in a form-fitting fashion in order to fix the wiper blade in the groove without other auxiliary means.

According to an enhancement of the present disclosure, the inner region has a cross section in the shape of a sector of a circle and the leg of the wiper blade is pivotable about an axis extending in its longitudinal direction in the inner region. In this way, the wiper blade can respectively tilt in accordance with the direction of the wiping motion without having to bend.

According to a first alternative, the wiper blade may feature a leg that is immovably fixed in the groove, a pivotable outer section and a hinge section, particularly an integral hinge, between the leg and the outer section.

According to a second alternative, the wiper blade may be anchored with the aid of pins extending across the groove in order to realize a translation of the wiper blade from one sidewall of the groove to the opposite sidewall during each change of the wiping direction. In this case, it is advantageous if the outlet openings are arranged centrally between two pins. If the wiper blade jams and gets stuck at the pins, the outlet opening can thereby still be tightly closed due to the flexibility of the wiper blade.

In order to allow a simple and cost-effective manufacture of the windshield wiper, the supply conduit may be realized in the form of a channel that is recessed into the sidewalls and/or a bottom of the groove. The channel should extend as far as the outlet opening. The channel is closed by the wiper blade inserted into the groove such that a conduit with closed cross section is formed. Sufficient pressure for spraying the cleaning fluid through the outlet openings can be built up.

### BRIEF DESCRIPTION OF THE DRAWINGS

The present disclosure will hereinafter be described in conjunction with the following drawing figures, wherein like numerals denote like elements.

FIG. 1 shows a side view of the windshield wiper;

FIG. 2 shows a cross section through a windshield wiper with a wiper blade, which can be tilted about its longitudinal axis, according to an embodiment of the present disclosure;

FIG. 3 shows a cross section through a windshield wiper according to another embodiment along the plane III-III in FIG. 4, wherein the wiper blade is anchored with the aid of pins extending across the groove;

FIG. 4 shows a longitudinal section through the windshield wiper along the plane IV-IV in FIG. 3;

FIG. 5 shows a one-piece wiper blade according to another embodiment of the present disclosure;

FIG. 6 shows a cross section through a windshield wiper assembled of the wiper blade according to FIG. 5 and a bracket;

FIG. 7 shows a longitudinal section through the windshield wiper according to FIG. 6;

FIG. 8 shows a cross section through a windshield wiper according to another embodiment of the present disclosure; and

FIG. 9 shows a longitudinal section through the windshield wiper according to FIG. 8.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

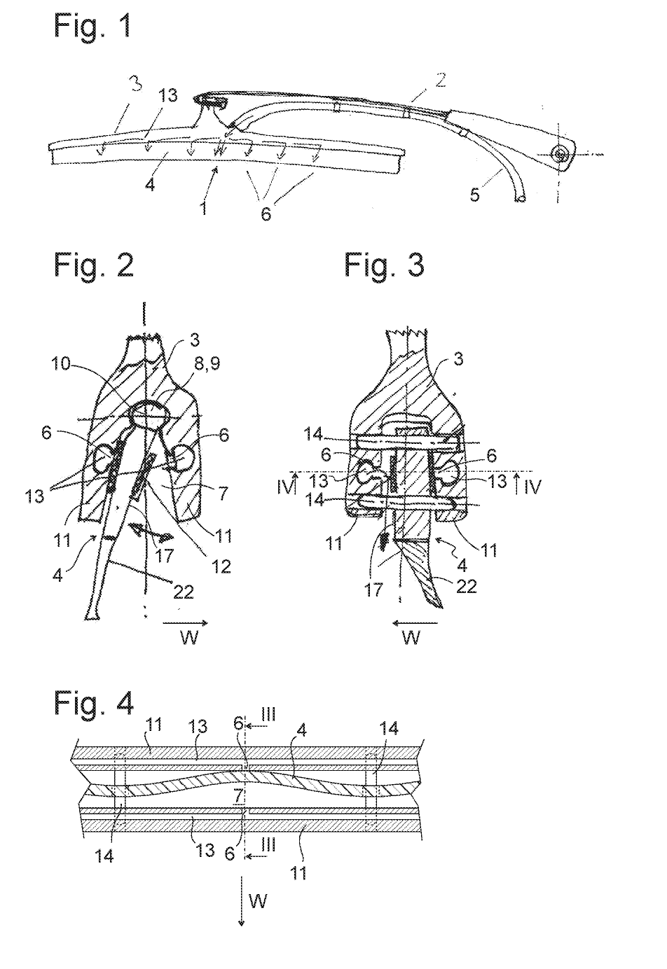

FIG. 1 shows a windshield wiper 1 that includes a wiper bracket 3 mounted on a wiper arm 2 of a motor vehicle. A wiper blade 4 is fixed on the wiper bracket 3. A supply conduit 5 for cleaning fluid includes a hose fastened on the wiper arm 2 by clamps. The supply conduit 5 extends up to a connection piece of the wiper bracket 3, as well as a distribution line 13 that leads to outlet openings 6 arranged along the wiper blade 4 in the wiper bracket 3.

FIG. 2 shows a cross section through a wiper bracket 3 and a wiper blade 4 according to an embodiment of the present disclosure. A groove 7 is recessed in the wiper bracket 3. The leg 9 of the wiper blade 4 is inserted in a form-fitting fashion into an undercut inner region 8 of the groove 7. The inner region 8 has a cross section in the shape of a sector of a circle. In this way, the leg 9 of the wiper blade 4 is pivotable in the inner region 8 about an axis 10 extending in the longitudinal direction of the wiper blade 4 and perpendicular to the plane of section of FIG. 2. The wiper blade 4 pivots from one sidewall 11 of the groove 7 to the opposite sidewall 11 and closes the outlet openings 6 located in this sidewall 11 during each change of the wiping direction. In addition, seals 12 may also be arranged on the wiper blade 4 and positioned on the outlet openings 6 during a wiping motion. When the windshield wiper 1 moves toward the right, the outlet openings 6 on the left sidewall 11 are tightly sealed by the wiper blade 4 whereas fluid can be discharged from the outlet openings 6 on the right sidewall 11 and flow onto the windshield in front of the wiper blade.

Leg 9 may be realized shorter than a wiping lip 22 of the wiper blade 4 that rests against the windshield and extends over the entire length of the bracket 3. In this way, it is ensured that the leg 9 can on the one hand extend linearly along the pivoting axis 10 and on the other hand be accommodated in the curved bracket. In such instances, the leg 9 may be rigid whereas the wiping lip 22 integrally formed on the leg 9 is flexible in order to adapt to the curvature of the windshield. However, it is also conceivable that the leg 9 extends along the entire bracket 3 in an arc-shaped fashion. For this purpose, the leg is made of an elastically pliable material like the wiping lip 22.

In an alternative embodiment as illustrated in FIG. 3, the wiper blade 4 is anchored in the wiper bracket 3 with the aid of pins 14 extending across the groove 7. The wiper blade 4 ideally slides from one sidewall 11 of the groove 7 to the other sidewall during each change of the wiping direction. In this way, the outlet openings 6 on the rear sidewall 11 relative to the wiping direction (the right sidewall in FIG. 3) are always closed by the wiper blade 4 whereas the outlet openings 6 in the front sidewall 11 relative to the wiping direction W are open. For this purpose, the wiper blade 4 may be divided into a rigid leg 9, which carries out a pendulum motion between the sidewalls 11 of the groove 7 without deforming, and a flexible wiping lip 22 like the wiper blade according to FIG. 2.

The entire wiper blade 4 may alternatively be flexible. If the wiper blade 4 jams and gets stuck at the pins 14 in this case, it can bend between the pins 14 due to the friction of the wiping lip on the windshield to such a degree that it tightly seals the outlet openings on the rear sidewall 11 relative to the wiping direction W, which are centrally arranged between two pins 14 as illustrated in the longitudinal section according to FIG. 4.

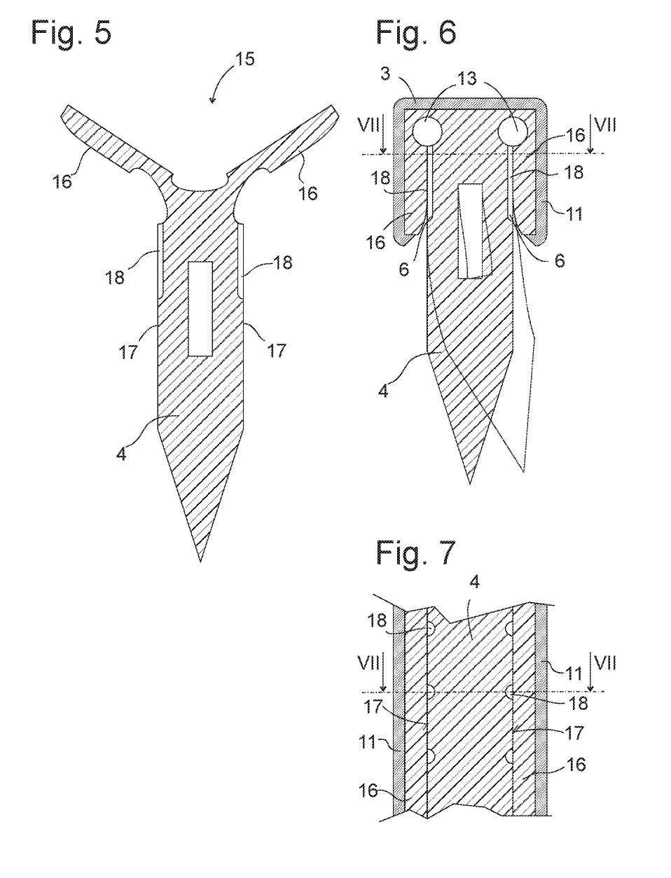

FIG. 5 shows a cross section through an extruded rubber profile 15, in which the wiper blade 4 and two webs 16 hinged to the wiper blade 4 are realized in one piece. Parallel channels 18 are recessed on flanks 17 of the wiper blade 4 at uniform distances from the plane of section. The extruded profile 15 is provided for being clamped into the groove 7 of the wiper bracket 3 such that its webs 16 are folded against the flanks 17 of the wiper blade 4 as illustrated in FIG. 6. The webs 16 form the distribution line 13 in that they are folded against the flanks 17. The channels 18 are closed over the majority of their length by the webs 16 folded against the flanks 17 of the wiper blade 4 and therefore form conduits with a closed cross section as illustrated, in particular, in FIG. 7 that shows a longitudinal section along the plane VII-VII in FIG. 6. These conduits are only open on their ends lying opposite of the distribution line 13 when the wiper blade 4 is relaxed in order to thereby form the outlet openings 6. When the wiper blade 4 is laterally deflected in an elastic fashion during its wiping motion over the windshield, the channels 18 are on one side of the wiper blade 4 closed over their entire length by the opposing web 16 and cleaning fluid can only be discharged through the channels 18 on the opposite side of the wiper blade 4, which lies in front of the wiper blade 4 referred to the moving direction of the windshield wiper 1.

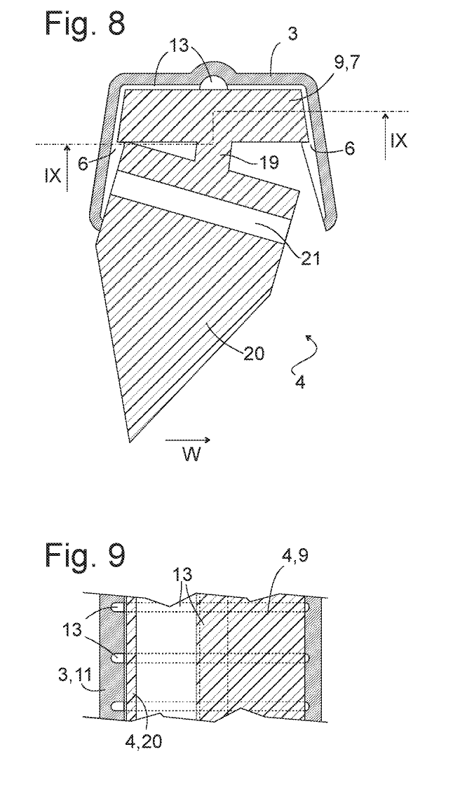

FIG. 8 and FIG. 9 show sections through a windshield wiper 1 according to another embodiment of the present disclosure. The one-piece wiper blade 4 of rubber includes a leg 9, a hinge section 19 and a pivotable outer section 20. The leg 9 is immovably fixed in the groove 7 of the wiper bracket 3 with a positive fit. In this case, the distribution line 13 is defined by channels recessed in the wiper bracket 3 and plane surfaces of the leg 9 lying opposite of the channels; however, the distribution line 13 could likewise be defined by channels recessed in the leg 9 and opposing plane surfaces of the bracket 3 or by opposing channels of the leg 9 and the bracket 3. During each change of the wiping direction, the pivotable outer section 17 pivots toward the rear side of the bracket 3 referred to the wiping direction at the hinge section 16 and thereby seals the outlet openings 6 of the distribution line 13 on this side.

According to a variation, the pivotable outer section 20 additionally features transversely extending passages 21 that respectively rest against the rear side of the bracket 3 relative to the wiping direction and are aligned with the local outlet openings 6. In this way, cleaning fluid is deflected from this side toward the opposite side and flows onto the windshield on the front side of the wiper blade 4 relative to the wiping direction W.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A windshield wiper for a motor vehicle comprising:
an elongate wiper blade having a first fluid outlet formed in a first side of the wiper blade and a second fluid outlet form in a second side of the wiper blade opposite the first blade; and
a supply conduit configured to selectively supply cleaning fluid to the first and second fluid outlets.

16. The windshield wiper according to claim 15, further comprising a plurality of first fluid outlets distributed along the first side of the wiper blade and a plurality of second fluid outlets distributed along the second side of the wiper blade, wherein the supply conduit includes a distribution line that extends along the wiper blade between the first and second fluid outlets.

17. The windshield wiper according to claim 15, further comprising a directional control valve configured to alternately supply cleaning fluid to the first fluid outlet and the second outlet based on a wiping direction of the wiper blade.

18. The windshield wiper according to claim 17, further comprising an articulated wiper blade configured to tilt about a longitudinal axis, wherein the directional control valve is configured to supply the first fluid outlet on the first side when the wiper blade is tilted toward the second side and the second fluid outlet on the second side when the wiper blade is tilted toward the second side.

19. The windshield wiper according to claim 15, further comprising a wiper bracket having a groove with at least one sidewall, the wiper blade being accommodated in the groove such that the at least one sidewall and a flank of the wiper blade lying opposite the at least one sidewall are spaced apart from one another.

20. The windshield wiper according to claim 19, wherein the groove in the wiper bracket forms a first sidewall and a second sidewall, the wiper blade being accommodated in the groove such that the first sidewall and a first flank lying opposite the first sidewall are spaced apart from one another and the second sidewall and a second flank lying opposite the second sidewall are spaced apart from one another.

21. The windshield wiper according to claim 19, wherein the first fluid outlet leads into a first gap between the flank of the wiper blade and the at least one sidewall opposing the flank.

22. The windshield wiper according to claim 21, wherein the supply conduit comprising a downstream section extending in the sidewalls of the groove.

23. The windshield wiper according to claim 19, wherein the groove comprises an undercut inner region into which a leg of the wiper blade engages in a form-fitting fashion.

24. The windshield wiper according to claim 23, wherein the inner region has a cross section in the shape of a sector of a circle and the leg of the wiper blade is pivotable about an axis extending in a longitudinal direction in the inner region.

25. The windshield wiper according to claim 19, wherein the wiper blade comprises a leg immovably fixed in the groove, a pivotable outer section and a hinge section between the leg and the outer section.

26. The windshield wiper according to claim 25, further comprising at least one pin extending across the groove to anchor the wiper blade.

27. The windshield wiper according to claim 26, further comprising two pins spaced apart along the groove such that at least one of the first and second fluid outlets is centrally arranged therebetween.

28. The windshield wiper according to claim 24, wherein at least part of the supply conduit comprises a channel recessed into the at least one sidewall or a bottom of the groove.

29. The windshield wiper according to claim 27, wherein the channel extends up to at least one of the first or second fluid outlets.
